(19) United States
(12) Patent Application Publication
(10) Pub. No.: US 2024/0103131 A1
(43) Pub. Date: Mar. 28, 2024

(54) RADAR-BASED ENVIRONMENTAL DETECTION SYSTEM FOR MOTOR VEHICLES

(71) Applicant: Robert Bosch GmbH, Stuttgart (DE)

(72) Inventors: Daniel Niederloehner, Stuttgart (DE); Florian Drews, Renningen (DE); Michael Ulrich, Stuttgart (DE); Ruediger Jordan, Stuttgart (DE); Sascha Braun, Eningen Unter Achalm (DE)

(21) Appl. No.: 18/448,334

(22) Filed: Aug. 11, 2023

(30) Foreign Application Priority Data
Sep. 26, 2022 (DE) 10-2022-210119.7

(51) Int. Cl. G01S 7/41; G01S 13/89

(52) U.S. Cl. CPC G01S 7/417; G01S 13/89

(57) ABSTRACT

A radar-based environmental detection system for motor vehicles. The system includes at least one radar sensor for providing location data regarding objects in the environment of the motor vehicle, and including a neural network for converting the location data into an environmental model which represents spatio-temporal object data of the objects. The neural network is conditioned to give priority to outputting environmental models in which at least one predetermined physical relationship between the location data and the object data is satisfied.

### CROSS REFERENCE

The present application claims the benefit under 35 U.S.C. § 119 of German Patent Application No. DE 10 2022 210 119.7 filed on Sep. 26, 2022, which is expressly incorporated herein by reference in its entirety.

### FIELD

The present invention relates to a radar-based environmental detection system for motor vehicles, comprising at least one radar sensor for providing location data regarding objects in the environment of the motor vehicle, and comprising a neural network for converting the location data into an environmental model representing spatio-temporal object data of the objects.

### BACKGROUND INFORMATION

Driver assistance systems for motor vehicles and systems for automated driving require detailed information regarding objects in the vehicle's environment. These objects are, for example, other road users, obstacles or the course of the roadway.

Environmental sensors such as radar, video or lidar scan the surroundings and provide the necessary measurement data regarding objects in the vehicle environment. With conventional systems, a tracking and fusion algorithm (for example, a Kalman filter) is used to aggregate or filter the measurement data over time and to add additional attributes. Such attributes are, for example, a derived velocity, acceleration or rotation rate. An environmental model is built from all tracked objects, on which model the driver assistance function or automated driving function can be based. The environmental model is represented by a set of data, referred to here as spatio-temporal object data. These data are location coordinates of specified points of the objects, for example the vertices of bounding boxes for each object, as well as time derivatives of these location coordinates.

Up to now, radar-based environmental detection has used mathematical methods such as Bayesian filters. For this purpose, both the object model and the object motion must be modeled using physical equations. When certain boundary conditions are met, for example white, Gaussian measurement noise, these filters operate optimally, i.e., the filter produces the best possible estimate of an object state. Unfortunately, such boundary conditions are often not met in practice, and therefore the environmental model does not accurately reflect reality. Furthermore, not all problems in object tracking can be solved by an optimal mathematical approach. Many sub-algorithms, such as the creation of new object tracks, the measurement data association, or the deletion of implausible tracks, are frequently solved by means of heuristic methods that have been found by experts through experience. The optimization of these methods is often very time-consuming, because many parameters have to be set and tested manually.

In contrast, an environmental detection system of the type mentioned at the outset uses machine learning methods. No physical model is used as a basis, and expert knowledge of physics plays only a subordinate role. Instead, a neural network is trained to derive the environmental model from the location data. The more extensive the training data and the more memory and computing power available, the more realistic the result.

However, in a real driver assistance system, memory and computing time are not unlimited. Training data are also expensive and therefore only available to a limited extent. As such, up to now, it cannot be ruled out with the necessary certainty that the neural network sometimes delivers implausible or grossly incorrect results.

### SUMMARY

An object of the present invention is to improve the quality of environmental detection by means of a neural network.

According to the present invention, this object may be achieved in that the neural network is conditioned to give priority to outputting environmental models in which at least one predetermined physical relationship between the location data and the object data is satisfied.

The at least one physical relationship represents a relationship, based on physical laws, between the location data measured by the radar sensor and the object data to be generated by the neural network and/or a relationship between the object data. The particular relationship or physical relationships is/are a priori knowledge regarding physical laws that is fed into the neural network in addition to the training data and results in outcomes that contradict physical laws being suppressed. The necessary conditioning of the neural network can consist of a special way in which the network is trained and/or of a special architecture of the network which forces it to respect physical laws. In any event, conditioning causes the network to give priority to outputting environmental models that are consistent with physical laws. In this connection, “priority” means that if noisy input data are fed into the network, there is an increased probability that the predetermined physical relationships are at least approximately satisfied in the environmental model generated by the network, while results that contradict such laws are statistically less likely to occur.

By using prior knowledge of physics, it is possible to obtain reliable results despite a limited supply of training data and despite limited computational capacity and limited computational time.

Advantageous embodiments of the present invention are disclosed herein.

In one example embodiment of the present invention, the network is trained at least in phases with synthetically generated training data corresponding to scenarios in which physical laws are exactly satisfied. As a result, the network learns to recognize such scenarios rather than non-physical scenarios.

Another way to condition the network consists of the fact that the changes made to the weights of the neural connections when training the network are not determined solely by the target/actual deviation, but also by the extent to which physical laws are satisfied or violated.

According to an example embodiment of the present invention, in the case of a deep neural network, filters may also be provided between the different layers to convert the output data provided by the lower layer into input data for the next higher layer in such a way that violations of physical laws are eliminated.

According to an example embodiment of the present invention, instead of such a filter, one or more hidden layers that are specially trained to enforce compliance with physical laws may be provided.

In the following, exemplary embodiments are explained in more detail with reference to the figures.

### BRIEF DESCRIPTION OF THE DRAWINGS

FIG. 1 shows a block diagram of an environmental detection system according to an example embodiment of the present invention.

FIG. 2 shows a diagram for describing a possible mode of operation of the environmental detection system of FIG. 1.

FIG. 3 shows a block diagram of a neural network in an environmental detection system according to another exemplary embodiment of the present invention.

### DETAILED DESCRIPTION OF EXAMPLE EMBODIMENTS

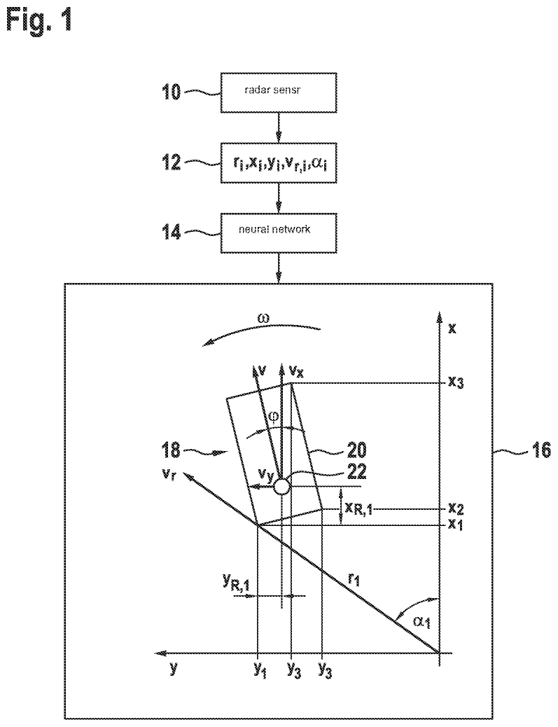

The environmental detection system shown in FIG. 1 comprises a radar sensor 10 that is installed in a motor vehicle in such a way that it can locate objects in a specific part of the vehicle's environment, for example in the space in front of the vehicle, and outputs corresponding location data 12. Generally, a single object will have a plurality of centers of reflection from which radar echoes are received. The location data 12 then comprise, for each center of reflection i, the distance ri, the radial velocity vri, i.e., the relative velocity of the center of reflection in the direction along the visual beam from the radar sensor to the center of reflection, and the azimuth angle ai of the center of reflection relative to the forward direction of the vehicle.

A certain amount of preprocessing of the location data can also take place in the radar sensor, for example in the form of calculating the Cartesian coordinates xᵢ and yᵣ, in the direction x parallel to the longitudinal axis of the vehicle and the direction y perpendicular (horizontal) thereto, from the distance rᵢ and the azimuth angle αᵣ of each object.

The location data 12 are fed into a neural network 14, which is trained to derive from these location data an environmental model 16 that indicates the location and, where possible, also the shape and orientation of each object in the Cartesian coordinate system x, y. In the example shown, the radar sensor 10 has detected only a single object 18, such as a passenger car, the rough outline shape of which is represented by a bounding box 20. Of the four corners of the object 18, three corners are visible from the radar sensor 10, i.e., from the origin of the coordinate system. It can be assumed that there is a center of reflection near each of these three corners, so that the location data 12 comprise, inter alia, the coordinates (x₁, y₁) , (x₂, y₂) and (x₃, y₃) of the three visible vehicle corners. In addition, there will generally be other centers of reflection at the rear of the vehicle and on the visible side surface.

The location data 12 also comprise the azimuth angles ai of the three visible corners and the radial components y r of the relative velocities of these three corners. For clarity, the azimuth angles and relative velocities in FIG. 1 are shown only for the corner (x₁, y₁).

Based on the location coordinates and the motion data, the neural network 14 can associate all three visible corners with the same object 18 and, based on the size relationships, conclude that this object is likely to be a passenger car, and then add the associated bounding box 20. Using the longer edges of the bounding box 20, the neural network can also determine the yaw angle φ of the object.

5 FIG. 1 also shows, as vectors, the relative velocity v of the object 18 and the components vₓ, v_{y} of this relative velocity. However, these quantities cannot be measured directly using the radar sensor 10, but must be derived from the available location data 12. Although the neural network 14 can be trained to estimate these object data that cannot be directly measured, the estimation result can be significantly improved, in particular for relatively noisy location data, by additionally considering what physical relationships exist between such quantities. Here, the term “physical relationships” is to be understood in a comprehensive sense and is also intended to include geometric relationships.

For example, for each center of reflection that has the azimuth angle α and distance r, there is a relationship given by formula (1) below between the measurable radial velocity vᵣ and the components vₓ and v_{y} of the velocity v of the object 18.

vᵣ=(v_{y}−ω·x_{R})·sin (α)+(v_{x+w}·y_{R})·cos (α) (1)

This relationship is based on the consideration that the measured radial velocity vᵣ is also dependent on the angular velocity ω at which the object 18 rotates about a center of rotation 22, which in a passenger car is typically near the center of the rear axle. In equation (1), x_{R} and y_{R} designate the distances between the center of rotation 22 and the center of reflection under consideration in the x and y coordinate directions. In FIG. 1, these distances are shown for the corner point (x₁, y₁).

The neural network 14 is conditioned to take into account, when estimating the object data vₓ, v_{y} and v, that the relationship given by formula (1) must be satisfied for each of the three visible corner points of the object 18, and indeed for all three points with the same angular velocity ω, which moreover must also coincide with the time derivative of the yaw angle φ.

For example, some hidden layers of the neural network 14 can be trained to explicitly estimate the angular velocity ω and evaluate the consistency of the estimated value with the four conditions mentioned above. The estimation is based, inter alia, on the hypothesis that the corner point (x3, y3), for example, actually belongs to the same object 18 as the other two corner points. However, if it turns out that the relationship according to formula (1) is poorly satisfied for this corner point, this can lead, in downstream layers of the network, to the hypothesis being rejected and instead an environmental model that is based on a different assignment of centers of reflection to objects being generated.

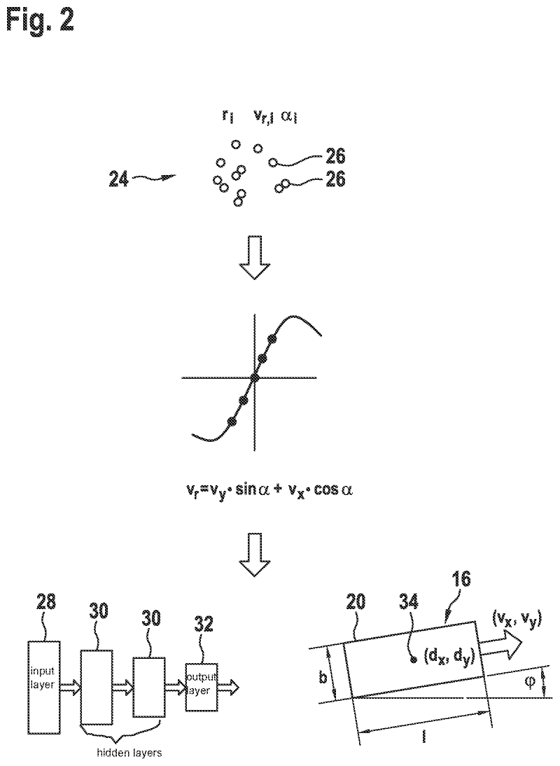

In FIG. 2, the mode of operation of the neural network 14 is illustrated by a simplified example, in which it is assumed that the angular velocity co of the object 18 is negligible. The input data for the neural network 14 are the measured distances ri, radial velocities v_{r,i}, and azimuth angles αᵢ of a point cloud 24 of measurement points 26. As a working hypothesis, it is assumed that all mixing points 26 belong to the same object.

Assuming ω=0, formula (1) simplifies to the formula

vᵣ=v_{y}·sin (α)+vₓ·cos (α) (2)

The network is trained to provide estimated values for vₓ and v_{y}, for which the relationship given in formula (2) is satisfied.

In the example shown, the network has an input layer 28, to which the input data are fed, and two hidden layers 30 and an output layer 32, in which the input data are gradually converted into output data (including estimated values for vₓ and v_{y}), which ultimately represent the environmental model 16. In this example, the object data output from the output layer 32 also comprise the width b and length l of the bounding box 20 and the coordinates (dₓ, d_{y}) of the geometric center 34 of the bounding box.

If a neural network is trained using training data, the weights of the neural connections are usually changed to minimize the so-called loss function L (loss). This loss function L gives the mean square deviation of the estimated values output by the network from the true values of the object data.

However, to condition the neural network 14 for the relationship according to formula (2), the loss function is modified by adding, to the usual loss function L, a physical term Lₚ which is defined as follows:

Lₚ=(1/n) Σ^{N}ᵢ₌₁ (V_{r,i,actual}−v_{x,pred} cos (αᵢ)−v_{y,pred} sin (αᵢ))² (3)

Therein, v_{r,i,actual} is the actual measured radial velocities of all N measurement points 26 belonging to the object, and v_{x,pred} and v_{y,pred} are the values of the velocity components predicted by the network.

If, in the training phase, the weights are set so as to minimize the total loss function L+Lₚ, the physical term Lₚ causes the weights to be set to those values at which the network predicts velocities vₓ, v_{y} which minimize the function

Δ(vᵣ, α)=vᵣ−v_{y}·sin α−vₓ·cos α

Here, Δ(vᵣ, α) equal to 0 would mean that the condition according to formula (2) is exactly satisfied. In this way, the network learns to preferentially return results that are consistent with this condition.

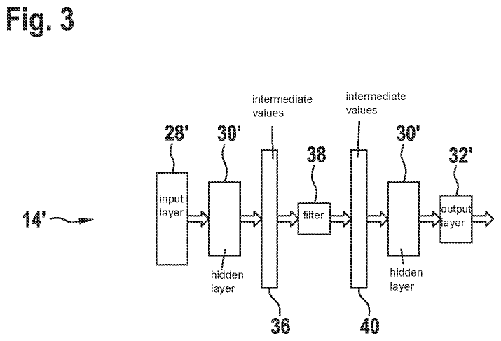

FIG. 3 schematically shows an architecture of a neural network 14′ according to another exemplary embodiment. This network has an input layer 28′, two hidden layers 30′ and an output layer 32′. The input layer 28′ and the first hidden layer 30′ are trained to provide a set of intermediate values 36 which have a specific physical meaning. In a filter 38, these intermediate values 36 are converted into a second set of intermediate values 40. This conversion “forcibly” implements a physical relationship to which the network 14′ is to be conditioned. The second intermediate values 40 then form the input data for the second hidden layer 30′. This second hidden layer 30′ and the output layer 32′ are trained to convert the intermediate values 40 into the estimated values output by the network. In this case, the a priori knowledge of the physical relationships does not need to be learned, but is implemented with the help of the filter 38.

What is claimed is:

1. A radar-based environmental detection system for motor vehicles, comprising:
at least one radar sensor configured to provide location data regarding objects in an environment of the motor vehicle; and
a neural network configured to convert the location data into an environmental model which represents spatio- temporal object data of the objects, wherein the neural network is conditioned to give priority to outputting environmental models in which at least one predetermined physical relationship between the location data and the object data is satisfied.

2. The environmental detection system according to claim 1, wherein the neural network is conditioned by having been trained with synthetic training data which are compatible with the at least one predetermined physical relationship.

3. The environmental detection system according to claim 1, wherein the network is conditioned by the fact that in training the network for determining weights of the neural network, a loss function was used that contains a physical term which minimizes a deviation from the at least one predetermined physical relationship.

4. The environmental detection system according to claim 1, wherein the neural network is conditioned by including, between two layers, a filter that converts a first set of intermediate values into a second set of intermediate values according to the at least one predetermined physical relationship.

5. The environmental detection system according to claim 1, wherein at least two hidden layers of the neural network are trained to convert a first set of intermediate values into a second set of intermediate values according to the at least one predetermined physical relationship.
